(19) United States
(12) Patent Application Publication
(10) Pub. No.: US 2002/0163606 A1
(43) Pub. Date: Nov. 7, 2002

(54) Liquid crystal display devices having an electroluminescent backlight assembly

(76) Inventors: Adrian H. Kitai, Mississauga (CA); Kenneth A. Cook, Waterloo (CA)

Correspondence Address: DOWELL & DOWELL PC, SUITE 309, 1215 JEFFERSON DAVIS HIGHWAY, ARLINGTON, VA, 22202

(21) Appl. No.: 09/731,224

(22) Filed: Dec. 7, 2000

Related U.S. Application Data
(60) Provisional application No. 60/169,301, filed on Dec. 7, 1999.

(51) Int. Cl. G02F 1/1335

(52) U.S. Cl. 349/98

(57) ABSTRACT

Liquid crystal display having a liquid crystal device as a light switching element, and employing an electroluminescent (EL) element as the light source. A liquid crystal display according to the present invention has a liquid crystal device for controlling light transmission depending on image information, and a light source. The liquid crystal device includes a liquid crystal material layer, sealed between a pair of light permeable substrates, and transparent pixel electrodes which are driven by electrical signals corresponding to image information supplied to the device. A pair of light polarizers, aligned to each other, are disposed on the outer sides of the light permeable membranes. An EL backlight source is formed by sequentially stacking a first electrode, a dielectric layer, a phosphor layer, a transparent dielectric layer, and a transparent second electrode layer on a substrate to form a thick or thin film EL device structure, and light from the EL structure illuminates one side of the liquid crystal device.

### CROSS REFERENCE TO RELATED UNITED STATES PATENT APPLICATION

This patent application relates to U.S. Provisional patent application Serial No. 60/169,301, filed on Dec. 7, 1999, entitled LIQUID CRYSTAL DISPLAY DEVICES HAVING AN ELECTROLUMINESCENT BACKLIGHT ASSEMBLY.

### FIELD OF THE INVENTION

The present invention relates to a liquid crystal display having a liquid crystal device as a light switching element, and employing an electroluminescent (EL) element as the light source.

### BACKGROUND OF THE INVENTION

A liquid crystal display displays information by controlling the slate of orientation of the liquid crystal molecules which in turn controls the transmission of light. It is frequently provided with a backlight to enhance contrast and to enable visibility of the displayed information in a dark environment. In liquid crystal displays in use today, the backlight is enabled using different lighting technologies, depending on the size and usage of the display.

For example, in most desktop monitors, backlighting may be provided by a number of fluorescent tubes arranged in parallel, with a back reflector to enhance efficiency, and a diffuser layer at the front to provide more uniform illumination to the liquid crystal device. In other displays, a single serpentine fluorescent tube is the source of light. For thinner displays e.g. those used in a laptop computer, small diameter cold cathode fluorescent tubes are situated at one end or at opposing ends, of a light guide which directs the light towards the liquid crystal device. These are shown in FIGS. 1(a) and 1(b) discussed hereinafter.

Flourescent lamp sources are popular because they are highly efficient in terms of the electrical power consumed. However, they suffer from certain drawbacks. Light output degrades over time, and the degradation may be non-uniform over the length of the tube. However, recent developments have demonstrated lifetimes approaching 50,000 hours, see N. Noguchi, A 50,000-hour Lifetime Cold-Cathode Fluorescent Lamp for LCO Backlighting, SID Digest (1999) p. 908. Also, they may extinguish fully due to failure of the cathode, see Robert D. Smith-Gillespie and Daniel D. Syroid, 777 LCD Backlight Life SPIE Vol. 2219, Cockpit Displays (1994) p. 290. Being sizeable glass objects, they may break when subject to mechanical shock forces. Further, for larger, brighter displays the backlight assembly is heavy and has a depth of several centimeters.

For smaller liquid crystal displays in use, other types of light source are employed, the most common being powder EL and LED's. In powder EL, grains of EL material are dispersed in a resin binder and enclosed between two planar electrodes, one of which may be reflecting, the other being transparent and adjacent to the liquid crystal device, as shown in FIG. 1(c) discussed hereinafter. Powder EL backlights degrade quickly with use especially at high light output levels, where they typically have a life to half brightness of 2000 to 4000 hours. A limited color range is available, the most popular being a blue green color obtained from ZnS: Cu phosphor grains.

LEDs are stable and efficient devices and are deployed singly or in number in a backlight device in two different ways as shown in FIGS. 1(d) and 1(e). In FIG. 1(d), the LED is deployed directly behind the liquid crystal device with a diffuser to spread the light from the point-like source LED. In the edge lit device shown in 1(e), the light from the LED is directed into the edge of a plastic diffuser plate which in turn directs light to the liquid crystal device. Because of their point-like nature, LED based backlights may be non-uniform and are thus limited to smaller display types.

What has been described so far are the types of backlights in use in commercially available displays. In principle, many different lighting technologies and emissive display technologies such as powder EL, may be employed as the source of light in a backlight for a liquid crystal display. A monochromatic source is used in a monochromatic display. For example, a thin film EL (TFEL) backlight has been proposed where ZnS: Mn a bright, efficient EL phosphor provides the monochomatic (amber) light source, see U.S. Pat. No. 5,504,599 to Okibayashi et al. When properly sealed from atmospheric moisture, this phosphor has demonstrated stability in excess of 30,000 hours. In the same reference, other sulphide phosphors emitting colors other than amber are suggested, but they possess neither the brightness or the stability needed for a backlight. Also, a field emission lamp (FEL) device has been proposed as a backlight source for avionics applications where high brightness, power efficiency and robustness are important requirements, see A. I. Akinwande, Field Emission Lamps for Avionics LCD Backlighting, SID Digest (1999) p. 904.

Color displays in commercial use have a white light source, such as fluorescent tubes, as the backlight, and individual colors at the sub-pixel level are obtained by using color filters positioned in alignment with the sub-pixels of the liquid crystal device. If these filters are placed outside the plates retaining the liquid crystal material, a parallax effect between the filter array and the sub-pixel array in the liquid crystal device leads to a deterioration in performance known as color shift, an effect which can be reduced by reducing the thickness of one of the plates of the liquid crystal device.

An alternative approach to multicolor liquid crystal displays is the use of a multicolor emissive backlight, with an array of different color light sources aligned with the color sub-pixels of the liquid crystal device. Both photoluminescent (U.S. Pat. No. 4,793,691) and powder EL (see U.S. Pat. No. 4,772,885) light sources have been proposed.

A variation of the multi-color EL backlight is described in U.S. Pat. No. 5,504,599 to Okibayashi et al. where the colored lights from different TFEL phosphors are directed through the same pixel in the liquid crystal device. Different colors from the display are obtained by switching the color sources in synchronization with the timing of liquid crystal device pixels. A similar scheme employing organic LED (OLED) materials as the emissive light source is described in Ogawa et al., Field-Sequential-Color LCO Using Switched Organic EL Backlighting, SID Digest (1999) p. 1098. The problems facing backlight devices employing powder EL and TFEL phosphors have already been outlined herein. OLED materials represent a promising emissive technology for color displays. However at this time, problems remain to be solved, including aging of the materials especially at high temperatures, and limited operating life to half brightness, see Mark R. Vincen, An Analysis of Direct View FPDs for Automotive Multimedia Applications, Vehicle Displays and Microsensor, SID (1999) p. 39.

The backlit liquid crystal displays described so far are known as transmissive displays. In a bright ambient viewing environment, reflections from the display screen can reduce the observed contrast significantly, despite the inherently high transmission contrast which is currently available. Such effects may be partially offset by increasing the backlight intensity or by focusing the light output into a restricted viewing envelope.

A different kind of liquid crystal display which does not use a backlight is known as a reflective liquid crystal display. Ambient light enters the front surface, is reflected by a rear diffuse reflector, and emitted through the front surface having passed twice through the liquid crystal material. Both monochromatic and color displays are possible, with the latter employing color filters to filter individual colors from the ambient source of light.

Clearly such reflective displays are not useful in a dark environment. A hybrid type of display, based on employing both reflective and transmissive illuminations, overcomes this limitation. This type of hybrid device is known as a transflective liquid crystal display and has been employed, for example, in automobile displays where the transmissive mode is switched on and used only for viewing the display in the dark. Transflective operation is enabled by disposing a transflective layer between the backlight assembly and the rear surface of the liquid crystal device. Such a layer degrades both modes of operation, so that overall performance is a design compromise between the two.

### SUMMARY OF THE INVENTION

A first object of the invention is to provide a thin, robust backlit monochromatic liquid crystal display, having extended life (25-30,000 hours) and high luminance, which is relatively easy to manufacture and is available in a number of colors without the use of color filters.

The second object of the invention is to provide a thin, robust relatively low cost backlit monochromatic liquid crystal display, having improved performance characteristics, namely extended life (25-30,000 hours), uniform luminance, which is relatively easy to manufacture and is available in a number of colors without the use of color filters.

The third object of the invention is to provide a thin, robust color liquid crystal display with extended life.

The fourth object of the invention is to provide a thin, robust transflective monochromatic liquid crystal display, having improved performance characteristics including extended life (25-30,000 hours), high luminance and high contrast in a bright ambient environment, which is relatively easy to manufacture and is available in a number of colors without the use of filters.

The fifth object of the invention is to provide a thin, robust transflective color liquid crystal display, having improved performance characteristics including extended life and high contrast in a bright ambient environment.

A liquid crystal display according to the present invention has a liquid crystal device for controlling light transmission depending on image information, and a light source. The liquid crystal device comprises a liquid crystal material layer, sealed between a pair of light permeable substrates, and transparent pixel electrodes which are driven by electrical signals corresponding to image information supplied to the device. A pair of light polarizers, aligned to each other, are disposed on the outer sides of the light permeable membranes.

The light source is formed by sequentially stacking a metal electrode, a dielectric layer, a phosphor layer, a transparent dielectric layer, and a transparent electrode layer on a substrate to form a thick or thin film EL device structure, and light from the EL structure illuminates one side of the liquid crystal device.

The first object of the invention can be accomplished using certain classes of inorganic oxide color EL phosphors discussed hereinafter, which have demonstrated high luminance output and extended life. Being oxides, they do not react with atmospheric water vapor and oxygen and so minimal sealing is required in manufacturing the display.

The second object can be achieved using the same phosphor materials, and cost can be reduced by having the EL structure in the form of a narrow strip which is bonded to one end of a diffuser plate, which is attached to the liquid crystal device and which directs light from the EL strip to the said device.

The third object relating to a color display can be achieved by using the same phosphor materials to create a phosphor layer comprising a regular pattern of different color emitting phosphors, such that different color phosphors, red (R), green (G) and blue (B) say, are aligned with the respective R, G, B color sub-pixels of the liquid crystal device. Further, in order to reduce color shift, the EL structure and the liquid crystal device should be integrated in assembly by having the EL layer form one of the substrates of the liquid crystal device with the lower polarizing layer interposed between the EL layer and the liquid crystal layer.

The fourth object of the invention can be accomplished by adding a diffuse reflector layer under the phosphor layer, which is transparent, so that transmission is enhanced without compromising ambient reflection.

The fifth object is enabled by adding a diffuse reflector layer under the patterned phosphor layer of the color displays and by adding a patterned filter layer located between the EL phosphor layer and the front light permeable membrane, aligned with the color sub-pixels of the liquid crystal device and the patterned color phosphors so that the filter colors match the emitting colors of the phosphors, to provide a color display in the purely reflective mode of operation.

In one aspect the present invention provides a liquid crystal display device, comprising:

a light shutter having a front surface and a substantially transparent planar back plate (33); and

an electroluminescent backlight assembly (40) mounted with respect to said transparent planar back plate (33) of said light shutter so that light from said assembly (40) enters said light shutter through said transparent planar back plate (33), the electroluminescent backlight assembly (40) including an electroluminescent oxide phosphor layer (45).

In another aspect of the invention there is provided a display device (60), comprising;

an electroluminescent backlight assembly (61) including a support substrate (74), a first electrode (73) located on said support substrate (74), a first dielectric insulating layer (72) located on said first electrode (73), a patterned electroluminescent oxide phosphor layer (71) located on said first dielectric insulating layer (72), a substantially transparent dielectric insulating layer (70) located on said electroluminescent oxide phosphor layer (71), and a substantially transparent electrode (69) located on said transparent dielectric insulating layer (70), including a first polarizer (68) being located on said transparent electrode (69); and

a polarizer (68) mounted on said transparent electrode (69), a transparent electrode (64) spaced from said polarizer (68) and defining a volume there between containing a liquid crystal material (66), and a substantially transparent front planar plate (63) on said transparent electrode (64), and a second polarizer (62) located on said transparent front planar plate (63).

The above and other objects, features and advantages of the present invention will become clearer from the following description, when taken in conjunction with the accompanying drawings in which preferred embodiments of the invention are shown by way of illustrative example.

### BRIEF DESCRIPTION OF THE DRAWINGS

The invention will now be described, by way of example only, reference being had to the accompanying drawings, in which:

FIG. 1(a) illustrates a prior art edge-lit backlight for an LCD;

FIG. 1(b) illustrates a prior art backlight assembly for an LCD;

FIG. 1(c) Illustrates a prior art powder EL backlight for an LCD;

FIG. 1(d) illustrates a prior art LCD with direct LED backlight;

FIG. 1(e) illustrates a prior art LCD with edge LED illumination;

FIG. 2 is an exploded cross-sectional view of a first embodiment of a liquid crystal display constructed according to the present invention:

FIG. 3(a) is an exploded cross-sectional view of a liquid crystal display according to a second embodiment of the present invention;

FIG. 3(b) is a cross sectional view of an alternative embodiment of a backlight assembly used in the liquid crystal display;

FIG. 4(a) is an exploded cross-sectional view of a liquid crystal color display according to a third embodiment of the present invention;

FIG. 4(b) represents an operational view of the same display as in FIG. 4(a) showing how color sub-pixels are switched on/off by liquid crystal device,

FIG. 5 is an exploded cross-sectional view of a transflective liquid crystal monochromatic display according to a fourth embodiment of the present invention; and

FIG. 6 is an exploded cross-sectional view of a transflective liquid crystal color display according to a fifth embodiment of the present invention.

### BRIEF DESCRIPTION OF THE RELATED ART

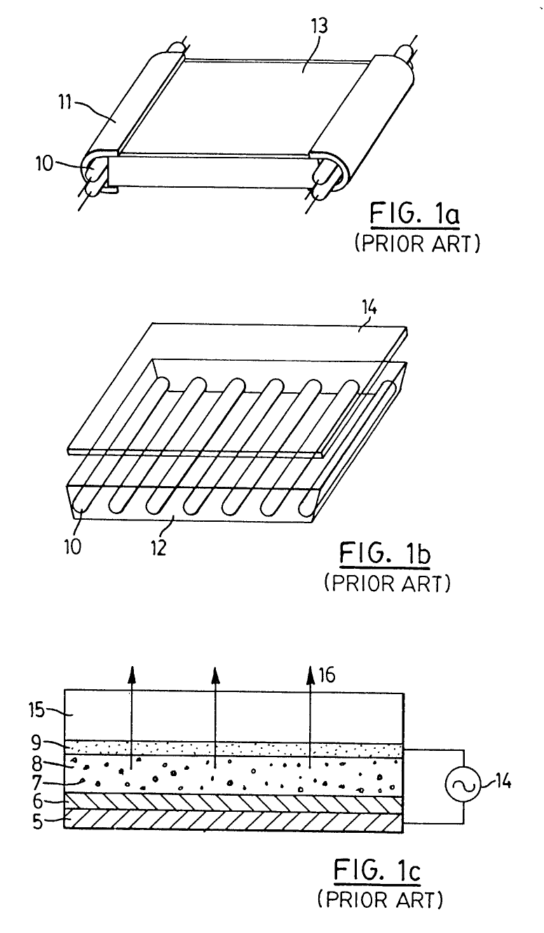

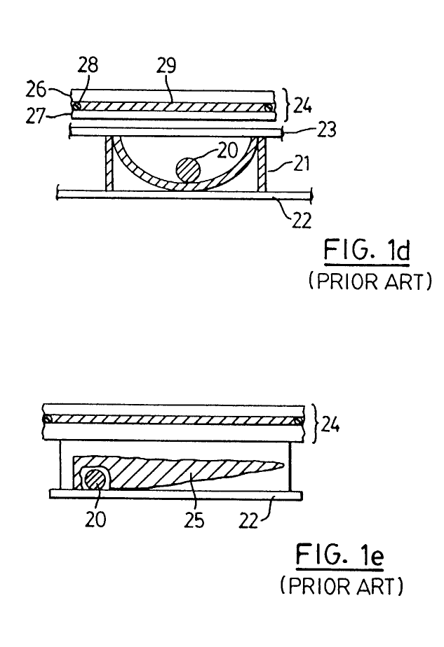

FIGS. 1(a) to 1(e) show several prior art designs of backlights for LCD devices. FIG. 1(a) illustrates an edge-lit backlight for an LCD including two fluorescent lamps 10 located on the edges of a light guide/diffuser plate 13 surrounded by a reflector assembly 11 for reflecting light into the diffuser plate. FIG. 1(b) Illustrates a backlight assembly for an LCD including several fluorescent lamps 10 with a back reflector assembly 12 and a diffuser plate 14. FIG. 1(c) illustrates a powder EL backlight for an LCD device including a reflecting rear electrode 5 on which is mounted an insulator layer 6, powder grains of an EL material 7 in a resin binder material layer 8 and a transparent electrode 9 on top of the EL layer. An A.C. voltage source 14 drives the light source which is covered with a protective transparent plastic sheet 15. FIG. 1(d) shows an LCD with direct LED backlight including an LED assembly 20 in front of a reflector assembly 21 mounted on a printed circuit board 22 with the light incident on a diffuser plate 23. The liquid crystal device 24 includes liquid crystal material 29 contained by glass substrates 26,27 and edge seal 28. FIG. 1(e) shows a prior art LCD device with edge LED illumination formed using an LED assembly 20 coupled with a light guide/diffuser plate 25 mounted on a printed circuit board 22.

### DETAILED DESCRIPTION OF THE INVENTION

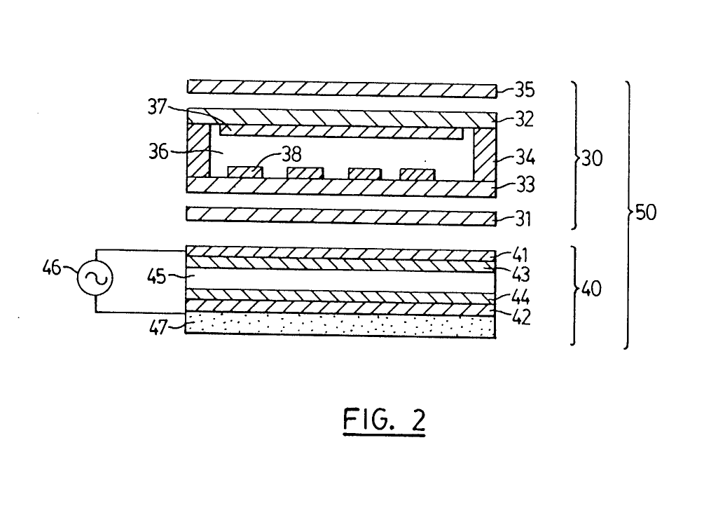

Referring to FIG. 2, an exploded cross-sectional view of a liquid crystal display 50 constructed according to the present invention comprises a liquid crystal device 30, comprising as its main elements a first polarizer 35, viewed by an observer, a second polarizer 31 with an axis of absorption parallel to that of polarizer 35, upper and lower plates (transparent) 32 and 33, a sealing member 34 between the plates 32 and 33, a liquid crystal material 36 contained within the enclosed volume defined between plates 32 and 33, counter electrode(s) (transparent) 37 attached to plate 32 on the interior of the enclosed volume, and pixel or segmented transparent electrodes 38 attached to plate 33 to create addressable elements that are driven by voltages corresponding to image information. The elements of liquid crystal device 30 constitute a 90° twisted nematic (TN) liquid crystal device serving as a light switching device or light shutter. However, the invention is not limited to this particular type of liquid crystal device. This description is not limited to passively addressed displays. Some types of liquid crystal devices use an active thin film transistor structure interposed between one of the transparent plates 32 or 33, and their adjacent electrode layers to continuously or actively apply voltage information to addressable elements of the display between addressing cycles. Further, some types of liquid crystal displays include a patterned multi-color filter, typically mounted to the front transparent plate 32, each pixel of the filter having a dedicated color in registration with an associated pixel of the liquid crystal display unit 30, to allow multiple colors to be displayed. Finally, for TN liquid crystal devices, polarizers 35 and 31 are required for the device to function as a light shutter mechanism. But it will be appreciated that in general, a light shutter using other types of materials and structures may not require these polarizers. For example, cholesteric displays act as a light shutter, and do not require polarizers.

The liquid crystal display also includes an EL light source 40 disposed below the liquid crystal device 30, comprising the following main elements, a support substrate 47, an electrode 42 mounted on substrate 47, a lower insulating layer 44 on top of electrode 42, an electroluminescent (EL) phosphor layer 45 on top of layer 44, an upper transparent insulating layer 43 on top of EL phosphor layer 45, a transparent electrode 41 on top of layer 43 and an A.C. voltage source 46 connected between electrodes 41 and 42. When an A.C. voltage of sufficient amplitude is applied to electrodes 41 and 42, the EL phosphor emits light which leaves the light source through the transparent electrode 41, and illuminates the liquid crystal device 30 at the rear polarizer 31. A light pattern corresponding to image information is emitted through the front polarizer 35 depending on the image information voltages applied between electrodes 37 and 38.

More particularly, the EL light source 40 comprises electrode 42 being formed by depositing a layer of silver of approximate thickness 1 μm on the support substrate 47 made of glass, quartz or ceramic such as alumina. The lower insulating layer 44 comprises a layer 3-20 μm thick of lead zirconium titanate (PZT) or some other dielectric material with a dielectric constant in the range from about 1,000 to about 10,000, and another interface layer composed of approximately 0.05 μm to 0.1 μm of SrTiO₃ or BaTiO₃ adjacent to the phosphor layer 45. The upper insulating layer 43 is also formed from SrTiO₃ in a range of thickness 0.05 μm to 0.1 μm. The PZT layer is preferably formed using a sol-gel process, while the SrTiO₃ layer is preferably formed by RF sputtering. Different colors of light are emitted by different phosphors e.g. green (G) from Zn₂Si_{0.5}Ge_{0.5}O₄: Mn, and red (R) from Ga₂O₃:Eu, wherein manganese (Mn) and europium (Eu) act as the centers of G and R light emission, and the zinc silico-germanate and the gallium oxide act as the respective host materials. Both these phosphors are formed by RF sputtering to form a phosphor layer 45, in the range 0.3 μm to 2.5 μm thick. The upper transparent electrode is formed by RF sputtering a layer of indium-tin-oxide (ITO) approximately 0.2 μm thick.

The preferred EL phosphors are inorganic oxide color EL phosphors as disclosed in U.S. Pat. No. 5,725,801 to Kitai et al., U.S. Pat. No. 5,897,812 to Kitai et al. and U.S. Pat. No. 5,788,882 to Kitai et al., all three references being incorporated herein in their entirety by reference, which have demonstrated high luminance output and extended life. Being oxides, they do not react with atmospheric water vapor and oxygen and so minimal sealing is required in manufacturing the display.

The EL device 40 thus described with the above-mentioned color phosphor oxides achieves high luminance output which increases with A.C. voltage amplitude and frequency and which is stable for periods of time in excess of 20,000 hours. These characteristics are superior to powder EL backlight performance. Further, the phosphor materials, being oxides, do not react with atmospheric water vapor and oxygen, and so do not require the isolating seal demanded by thin film EL devices based on sulphide phosphors such as ZnS:Mn, and is therefore easier to manufacture. The first object of the present invention is thus realized by the embodiment just described.

In the above embodiment, the backlight is an example of a thick film EL device, but the scope of the invention also includes a thin film EL (TFEL) structure with a thinner lower insulating layer. Also in the embodiment, the phosphor layer comprises a single phosphor; whereas the scope of the invention includes stacking different phosphors to provide a blended color, or putting different color phosphors side-by-side so that different areas of the display emit different colors.

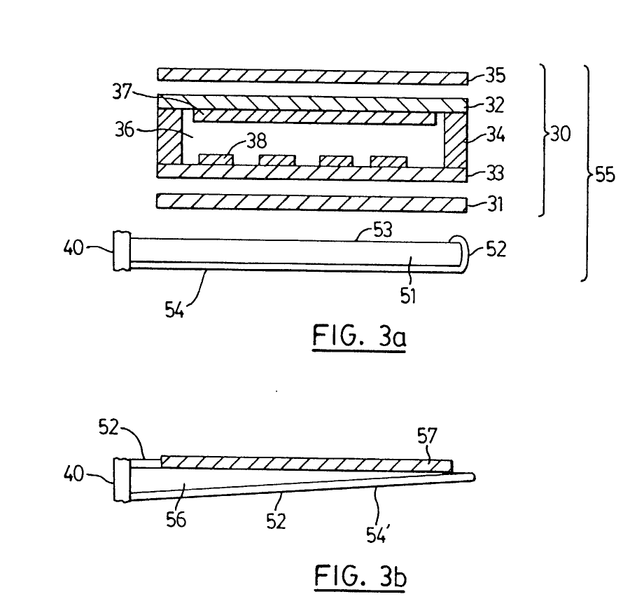

FIG. 3(a) shows another embodiment of an LCO shown generally at 55 produced in accordance with the present invention comprising liquid crystal device 30 as described with respect to FIG. 2, an EL light source 40 of the same layered structure described with respect to FIG. 2, in the form of a strip of width substantially smaller than the width of the display, an edge illuminated backlight assembly 54, a light guiding plate 51 and a reflective coating layer 52.

To form the backlight assembly 54, the EL light source 40 is attached along an edge of the light guiding plate 51, made of glass or transparent plastic, and the plate is coated by a thin diffuse reflective layer 52 such as textured aluminized foil on its surface apart from the area occupied by the EL strip device and the area 53 adjacent to the liquid crystal device 30. When the EL device 40 is activated by a sufficiently high A.C. voltage, the emitted light is directed in a uniform manner by the action of the light guiding plate 51 and the reflector layer 52 towards the liquid crystal device 30. It will be appreciated the edge EL assembly shown in FIGS. 3(a) and 3(b) may be constructed using many known phosphors.

The edge illuminated backlight assembly 54 thus described provides a uniform illumination over a larger area compared with an edge illuminated LED backlight, such as shown in FIG. 1(e). Further, the high luminous output from the EL structure provides a more stable and at least comparable level of illumination to the liquid crystal device, compared with a powder EL device as illustrated in FIG. 1(c). The second object of the present invention is thus realized by the second embodiment just described.

As in the first embodiment, the scope of the invention includes a thin film EL (TFEL) structure in the EL light source. Further, different phosphors are used to create different color backlights and can be stacked to create a composite color. Even further, different color phosphors may be arranged side-by-side along the length of the EL strip to create bands of color in the display, provided suitable light baffles are included within the light guide plate 51 to prevent color mixing at the edges of the said color bands. Also included in the scope of the invention is the use of multiple EL strips emitting light of the same, or different, colors along different edges of the light guide plate 51. Further, different embodiments of the light guide may be used such as the wedge shaped stepped reflector assembly shown in FIG. 1(e), or the wedge shaped reflector assembly 54′ shown in FIG. 3(b) that includes a light guiding wedge 56 and a textured light correcting plate 57. In the light guiding wedge 54′ of FIG. 3(b), the light emitted from EL light source 40 is guided by clear plastic wedge 56 and then focused to enhance brightness in the viewing cone by collecting plate 57.

Finally, all embodiments described so far allow for the disposition of a transflective sheet between the lower polarizer and the top surface of the backlight assembly. The top reflective surface of said sheet reflects ambient light impinging on the front viewing surface of the display, thus allowing purely reflective operation. The sheet is sufficiently transmissive to allow transmissive operation which may be necessary in some low level ambient lighting environments.

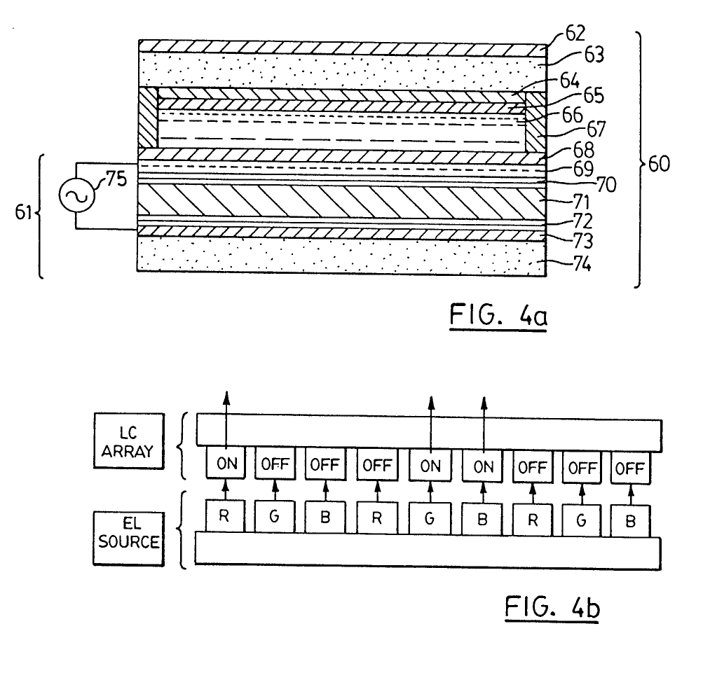

FIG. 4(a) is an exploded cross-sectional view of a liquid crystal color display 60 according to a third embodiment of the present invention; and FIG. 4(b) represents an operational view of the display showing how color sub-pixels are switched on/off by liquid crystal device, thereby transmitting or blocking the color emissions from an array of different color EL phosphors. LCD device 60 comprises an EL backlight 61 that includes a transparent ground electrode 69, an upper insulating or dielectric layer 70, patterned color emitting phosphor layer 71, a lower dielectric layer 72 and a lower electrode 73 on a substrate 74. An A.C. voltage source 75 is connected between electrodes 69 and 73. The EL backlight assembly 61 forms the lower substrate of the liquid crystal display 60. Display 60 also comprises a top polarizer 62 viewed by an observer, a top substrate 63, a liquid crystal device color sub-pixel electrodes 64, an orientation film 65, liquid crystal material 66, a seal 67 and a lower polarizer 68.

Apart from elements 71 and 64, the structure and function of the other elements are as described in the first embodiment of FIG. 2, except that the lower plate of the liquid crystal device is formed by the EL assembly, so that the display is a fully integrated combination of the liquid crystal device and the EL backlight. Such a construction minimizes color shift.

The patterned electroluminescent oxide phosphor layer 71 may comprise a regular pattern of color emitting phosphors, which could be realized as repeated stripes of RGB RGB . . . phosphors, but is not limited to such an arrangement. The color emitting phosphors are aligned with the color sub-pixel electrodes 64 in the liquid crystal device which allow the liquid crystal to transmit, block and control the brightness of the colored lights emitted by the different phosphors.

The formulations of green and red phosphors are described in the first embodiment. The blue phosphor may be a doped oxide phosphor. The dielectric layers 72 and 70 may be the same materials in the same thickness ranges as discussed with respect to layers 43 and 44 of the embodiment of FIG. 2.

The liquid crystal color display 60 as described provides a thin, mechanically rugged structure because of a thin film solid state construction of the backlight, which avoids the use of fluorescent lamp assemblies. The oxide phosphors employed share the benefits of conventional TFEL phosphors (e.g. ZnS:Mn) such as extended life and wide operating temperature range. However, they have the added advantage, being oxides, of compatibility with other materials. For example, not reacting with atmospheric water vapor or oxygen obviates the need for the extensive sealing required by sulphide phosphor based devices. Also, compatibility with the liquid crystal device materials allows integration of the EL backlight with the liquid crystal device. This integration eliminates most of the color shift that would otherwise occur due to the light passing through the rear transparent plate 33 of a typical LCD shutter device 30 as described in the embodiment of FIG. 2. The third object of the present invention is thus realized by the embodiment just described.

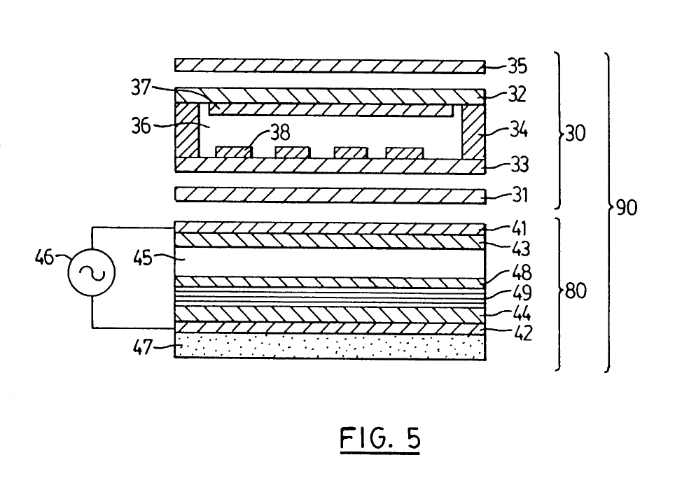

FIG. 5 is an exploded cross-sectional view of a liquid crystal display according to an embodiment of the present invention shown generally at 90. LCD 90 includes a liquid crystal device 30, as shown in FIG. 2 incorporating the same elements 31 through 38, and EL light source and reflector assembly 80 with elements 41 through 47 having the same form and function as in assembly 40 in FIG. 2; but with the addition of the following layers: transparent insulating layer 48 providing an interface between the phosphor layer 45 and diffuse reflecting layer 49. The reflecting layer provides a significant increase in intensity of light emitted through electrode 41 by the EL back light source 80, Note that under certain circumstances, the transparent insulating layer 48 is not required, such as when the reflecting layer 49 is has very low conductivity or is non-conductive, or when the reflecting layer 49 is patterned to provide electrically isolated small reflective pads.

The transparent insulating layer 48 is a sub-micron sputtered deposition of SrTiO₃, and the diffuse reflecting layer 49 is formed by evaporating a metallic layer on the surface of dielectric layer 44. This reflective layer may be used in EL backlight LCD devices not necessarily restricted to those disclosed herein using the preferred red, green and blue EL oxide phosphors.

The transmissive mode of operation is similar to that described in the first preferred embodiment, but is enhanced by the reflective layer 49 as light directed initially downward from the phosphor is reflected upward and out through the liquid crystal device.

The reflective mode of operating uses ambient light which enters the display through the liquid crystal device 30 and, is transmitted through the transparent layers of the assembly 80 and is then reflected back towards the viewer by reflecting layer 49. Since no transflecting layer is employed, the associated degradation of display intensity is avoided. Further, when the display is operated in a bright ambient environment, the reflective mode provides additional contrast to enhance the transmissive contrast provided by the liquid crystal device. The scope of the invention includes the addition of a color filter layer mounted on the top surface of the EL backlight assembly 80, or on the LCD assembly 30, the color filter selected so that a double pass of ambient light approximates the color of the phosphor emission as observed through the said filter. The fourth object of the present invention is thus realized by the embodiment just described.

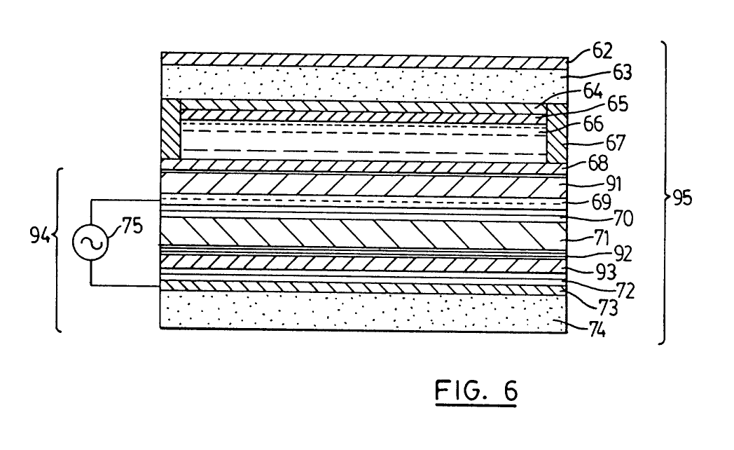

FIG. 6 illustrates another embodiment of the present invention which is a transflective liquid crystal display 95 having an EL backlight assembly 94 comprising elements 69 through 75 having the same structure and function as described in the third preferred embodiment (see FIG. 4), but including additional elements: a filter layer 91 with filter elements RGB aligned with the phosphor layer 71 RGB pattern, and the RGB sub-pixel electrode array 64, a transparent insulating layer 92 in contact with phosphor layer 71, a reflecting layer 93 for reflecting ambient light and light emitted from the phosphor layer 71. Layers 92 and 93 are formed in the same manner as layers 48 and 49 in the fourth preferred embodiment (see FIG. 5). Note that under certain circumstances, the transparent insulating layer 92 is not required, such as when the reflecting layer 93 is has very low conductivity or is non-conductive, or when the reflecting layer 93 is patterned to provide electrically isolated small reflective pads. The filter layer 91 is preferably interposed between polarizer 68 and electrode 69 but could also be between transparent front planar plate 63 and transparent electrode 64, or on the inner surface of plate 68, or between electrode 64 and plate 65, or on the inner surface of plate 65 adjacent to the liquid crystal material 66.

The EL backlight assembly 94 forms the lower substrate of the liquid crystal display 95 which also comprises layers 62 through 68 which have the same structure and function as described in the third preferred embodiment (see FIG. 4).

The resulting liquid crystal display 95 enables full color capability in both transmissive and reflective modes of operation. For example, the transmissive mode only is activated in a dark environment; and the EL backlight may be switched off in bright ambient conditions, resulting in a purely reflective mode of operation. As described in the previous embodiment, overall contrast is enhanced by the combination of both modes in a bright ambient viewing environment.

Since the filter must convert substantially white light to colored light using two passes through the filter, the color filter can be a low attenuation filter. This provides for efficient reflective mode operation while minimally reducing the efficiency of the emissive mode of operation.

The EL based display devices disclosed herein have commercial applicability in many industrially important display technologies.

The foregoing description of the preferred embodiments of the invention has been presented to Illustrate the principles of the invention and not to limit the invention to the particular embodiment illustrated. It is intended that the scope of the invention be defined by all of the embodiments encompassed within the following claims and their equivalents.

Therefore what is claimed is:

1. A display device (50), comprising:
a light shutter having a front surface and a substantially transparent planar back plate (33); and
an electroluminescent backlight assembly (40) mounted with respect to said transparent planar back plate (33) of said light shutter so that light from said assembly (40) enters said light shutter through said transparent planar back plate (33), the electroluminescent backlight assembly (40) including an electroluminescent oxide phosphor layer (45).

2. The liquid crystal display device according to claim 1 wherein said optical light shutter is a liquid crystal display unit (30) including a substantially transparent front planar plate (32) spaced from said back planar plate (33) with a liquid crystal material (36) sealed in a volume defined between planar plate (32) and planar plate (33), a first segmented electrode array (38) being mounted on an inner surface of plate (33) and a second segmented electrode array (37) being mounted on an inner surface of plate (32), and wherein said electroluminescent backlight assembly (40) includes a support substrate (47), a first electrode (42) located on said support substrate (47), a first dielectric insulating layer (44) located on said first electrode (42), said electroluminescent oxide phosphor layer (45) located on said first dielectric insulating layer (44), a substantially transparent dielectric insulating layer (43) located on said electroluminescent oxide phosphor layer (45), and a substantially transparent electrode (41) located on said transparent dielectric insulating layer (43), including a first polarizer (31) being located on said transparent back planar plate (33), and a second polarizer (35) located on said transparent front planar plate (32).

3. The liquid crystal display device according to claim 2 wherein said first dielectric insulating layer (44) includes a first dielectric layer located on said first electrode (42) having a dielectric constant in a range from about 1,000 to about 10,000 and a second dielectric layer sandwiched between said first dielectric layer and said electroluminescent oxide phosphor layer (45) having a thickness in a range from about 0.05 to about 0.1 μm.

4. The liquid crystal display device according to claim 3 wherein said first dielectric layer is lead zirconium titanate having a thickness in a range from about 3 μm to about 20 μm, and wherein said second dielectric layer is selected from the group consisting of SrTiO₃ and BaTiO₃.

5. The liquid crystal display device according to claim 4 wherein said transparent dielectric insulating layer (43) is SrTiO₃ having a thickness in a range from about 0.05 μm to about 0.1 μm.

6. The liquid crystal display device according to claim 2 wherein said electroluminescent oxide phosphor layer (45) is a green emitting oxide phosphor having a formula given Zn₂Si_{0.5}Ge_{0.5}O₄:Mn.

7. The liquid crystal display device according to claim 2 wherein said electroluminescent oxide phosphor layer (45) is a red emitting oxide phosphor having a formula given by Ga₂ O₃:Eu.

8. The liquid crystal display device according to claim 6 wherein said green emitting oxide phosphor layer has a thickness in a range from about 0.3 μm to about 2.5 μm.

9. The liquid crystal display device according to claim 7 wherein said red emitting oxide phosphor layer has a thickness in a range from about 0.3 μm to about 2.5 μm.

10. The liquid crystal display device according to claim 2 wherein said electroluminescent backlight assembly (40) includes a voltage source (46) connected between said first electrode (42) and said transparent electrode (41).

11. The liquid crystal display device according to claim 2 wherein said electroluminescent oxide phosphor layer (45) includes at least two electroluminescent oxide phosphor layers stacked one on top of the other, and which emit light of different wavelengths.

12. The liquid crystal display device according to claim 2 wherein said electroluminescent oxide phosphor layer (45) includes at least two electroluminescent oxide phosphors arranged side by side, and which emit light of different wavelengths.

13. The liquid crystal display device according to claim 2 including a color filter having an array of color pixels with at least two distinct colors of pixels, with each pixel in registration with an associated pixel of the liquid crystal display unit (30).

14. The liquid crystal display device according to claim 2 including a light guide plate (51) having a surface (53) located adjacent to said transparent planar plate (33) and a reflective coating (52) on a surface opposed to said surface (53), said electroluminescent backlight assembly (40) being mounted on an edge of said light guide plate (51).

15. The liquid crystal display device according to claim 14 including multiple electroluminescent backlight assemblies (40) being mounted along different edges of the light guide plate (51).

16. The liquid crystal display device according to claim 15 wherein said multiple electroluminescent backlight assemblies (40) mounted along different edges of the light guide plate (51) emit light of the same color.

17. The liquid crystal display device according to claim 15 wherein said multiple electroluminescent backlight assemblies (40) mounted along different edges of the light guide plate (51) emit light of different colors.

18. The liquid crystal display device according to claim 14 wherein said light guide plate is a wedge-shaped light guide plate (56), including a textured light correcting plate (57) on a front surface of said wedge-shaped light guide plate (56).

19. The liquid crystal display device according to claim 2, including a diffuse reflective layer (49) interposed between said electroluminescent oxide phosphor layer (45) and said first said first dielectric insulating layer (44).

20. The liquid crystal display device according to claim 19, including a transparent insulating layer (48) interposed between said electroluminescent oxide phosphor layer (45) and said reflective layer (49).

21. A display device (60), comprising:
an electroluminescent backlight assembly (61) including a support substrate (74), a first electrode (73) located on said support substrate (74), a first dielectric insulating layer (72) located on said first electrode (73), a patterned electroluminescent oxide phosphor layer (71) located on said first dielectric insulating layer (72), a substantially transparent dielectric insulating layer (70) located on said electroluminescent oxide phosphor layer (71), and a substantially transparent electrode (69) located on said transparent dielectric insulating layer (70), including a first polarizer (68) being located on said transparent electrode (69); and
a polarizer (68) mounted on said transparent electrode (69), a transparent electrode (64) spaced from said polarizer (68) and defining a volume there between containing a liquid crystal material (66), and a substantially transparent front planar plate (63) on said transparent electrode (64), and a second polarizer (62) located on said transparent front planar plate (63).

22. The liquid crystal display device according to claim 21 wherein said first dielectric insulating layer (72) includes a first dielectric layer located on said first electrode (73) having a dielectric constant in a range from about 1,000 to about 10,000 and a second dielectric layer sandwiched between said first dielectric layer and said phosphor layer (71) having a thickness in a range from about 0.05 to about 0.1 μm.

23. The liquid crystal display device according to claim 22 wherein said first dielectric layer is lead zirconium titanate having a thickness in a range from about 3 μm to about 20 μm, and wherein said second dielectric layer is selected from the group consisting of SrTiO₃ and BaTiO₃.

24. The liquid crystal display device according to claim 23 wherein said transparent dielectric insulating layer (70) is SrTiO₃ having a thickness in a range from about 0.05 μm to about 0.1 μm.

25. The liquid crystal display device according to claim 21 wherein said patterned electroluminescent oxide phosphor layer (71) includes a green emitting oxide phosphor having a formula given Zn₂Si_{0.5}Ge_{0.5}O₄:Mn.

26. The liquid crystal display device according to claim 21 wherein said patterned electroluminescent oxide phosphor layer (71) includes a red emitting oxide phosphor having a formula given by Ga₂O₃:Eu.

27. The liquid crystal display device according to claim 25 wherein said green emitting oxide phosphor layer has a thickness in a range from about 0.3 μm to about 2.5 μm.

28. The liquid crystal display device according to claim 26 wherein said red emitting oxide phosphor layer has a thickness in a range from about 0.3 μm to about 2.5 μm.

29. The liquid crystal display device according to claim 21 wherein said electoluminescent backlight assembly (61) includes a voltage source (75) connected between said first electrode (42) and said transparent electrode (41).

30. The liquid crystal display device according to claim 21 wherein said patterned electroluminescent oxide phosphor layer (71) includes at least two electroluminescent oxide phosphors arranged side by side, and which emit light of different wavelengths.

31. The liquid crystal display device according to claim 21, including a diffuse reflective layer (93) interposed between said patterned electroluminescent oxide phosphor layer (71) and said first said first dielectric insulating layer (72).

32. The liquid crystal display device according to claim 31, including an transparent insulating layer (92) interposed between said patterned electroluminescent oxide phosphor layer (71) and said reflective layer (93).

33. The liquid crystal display device according to claim 31, including a filter layer (91) having filter elements aligned in registration with the color elements of the patterned electroluminescent oxide phosphor layer (71) so that the wavelengths passed by the filter elements in the filter layer (91) are matched to the emission wavelengths of the color elements of said patterned electroluminescent oxide phosphor layer (71) in registration therewith.

34. The liquid crystal display device according to claim 30, wherein said first insulating layer (72) is substantially transparent and first electrode layer (73) is diffusely reflective, and which includes a filter layer (91) having filter elements aligned in registration with the color elements of the patterned electroluminescent oxide phosphor layer (71) so that the wavelengths passed by the filter elements in the filter layer (91) are matched to the emission wavelengths of the color elements of said patterned electroluminescent oxide phosphor layer (71) in registration therewith.

35. The liquid crystal display device according to claim 2, wherein a transflective layer is interposed between the lower polarizer (31) and a top surface of the backlight assembly (40).

36. The liquid crystal display device according to claim 2, wherein said first insulating layer (44) is substantially transparent and first electrode layer (42) is diffusely reflective.

37. The liquid crystal display device according to claim 36, wherein a filter layer selected so that the wavelengths passed by the filter layer are matched to the emission wavelengths of the electroluminescent oxide phosphor layer, is interposed between a top surface of the backlight assembly (40) and a top surface of the liquid crystal display device (30).

38. The liquid crystal display device according to claim 31, wherein the patterned electroluminescent oxide phosphor layer (71) emits in one uniform color.

39. The liquid crystal display device according to claim 34, wherein the patterned electroluminescent oxide phosphor layer (71) emits in one uniform color.

40. The liquid crystal display device according to claim 33, wherein said filter layer (91) is interposed between said electrode (69) and polarizer (68).

41. The liquid crystal display device according to claim 34, wherein said filter layer (91) is interposed between said electrode (69) and polarizer (68).

42. The liquid crystal display device according to claim 33, wherein said filter layer (91) is interposed between said transparent front planar plate (63) and transparent electrode (64).

43. The liquid crystal display device according to claim 34, wherein said filter layer (91) is interposed between said transparent front planar plate (63) and transparent electrode (64).

44. The liquid crystal display device according to claim 14 wherein a transflective layer is interposed between the lower polarizer (31) and a top surface of the backlight assembly (40).

45. The liquid crystal display device according to claim 18, wherein a transflective layer is interposed between the lower polarizer (31) and a top surface of the backlight assembly (40).
